(19) United States
(12) Patent Application Publication
(10) Pub. No.: US 2024/0232290 A1
(43) Pub. Date: Jul. 11, 2024

(54) OPTIMIZATION METHOD AND INFORMATION PROCESSING APPARATUS

(71) Applicant: Hitachi, Ltd.

(72) Inventors: Yusuke SUGITA, Tokyo (JP); Nobuo BENIYAMA, Tokyo (JP); Masanao YAMAOKA, Tokyo (JP)

(21) Appl. No.: 18/368,717

(22) Filed: Sep. 15, 2023

(30) Foreign Application Priority Data
Jan. 11, 2023 (JP) 2023-002594

(51) Int. Cl. G06F 17/18; G06F 17/16

(52) U.S. Cl. CPC G06F 17/18; G06F 17/16

(57) ABSTRACT

An object is to efficiently solve a quadratic programming problem having a k-hot constraint (k is a positive integer) for binary variables. A preferred aspect of the invention is an optimization method for, using an information processing apparatus, solving a quadratic programming problem in which one or more independent k-hot constraints are imposed on binary variables, the information processing apparatus including a processor, a storage device, an input device, and an output device. The information processing apparatus relaxes the binary variables into continuous values by adding correction values to a nonlinear coefficients of the binary variables on which the k-hot constraints are imposed, and the information processing apparatus executes a solution search while satisfying the k-hot constraints by executing a state transition such that a sum of a set of continuous variables on which the k-hot constraint is imposed is constant.

### CROSS-REFERENCE TO RELATED APPLICATION

The present application claims priority from Japanese application JP2023-002594, filed on Jan. 11, 2023, the content of which is hereby incorporated by reference into this application.

### BACKGROUND OF THE INVENTION

### 1. Field of the Invention

The present invention relates to an optimization method and an information processing apparatus.

### 2. Description of Related Art

JP2020-64535A (Patent Literature 1) describes a method for efficiently executing a ground state search based on simulated annealing by parallelizing energy calculation when k-hot constraints are imposed on variables of an Ising model having a second-order energy function.

WO2019/216277A1 (Patent Literature 2) describes a method for efficiently executing a ground state search based on simulated annealing by converting interaction relation of an Ising model having a second-order energy function into a complete bipartite graph structure.

WO2021/220445A1 (Patent Literature 3) describes a method for, regarding a mixed binary quadratic programming problem including a ground state search problem of an Ising model, efficiently executing a ground state search based on simulated annealing by converting interaction relation into a complete bipartite graph structure.

Z. I. Botev, “The normal law under linear restrictions: simulation and estimation via minimax tilting”, Journal of the Royal Statistical Society: Series B (2016) (Non-Patent Literature 1) describes a method for random sampling from a truncated normal distribution.

Many physical phenomena and social phenomena can be expressed by an interaction model. The interaction model is defined by a plurality of nodes constituting a model, nonlinear coefficients (or interaction coefficients) between the nodes, and linear coefficients (or bias coefficients) acting on each node if necessary. In fields of physics and social science, various models including the Ising model have been proposed, but all of the various models can be interpreted as one form of the interaction model.

A combinatorial optimization problem for obtaining a combination of variables that minimizes (or maximizes) an objective function can also be expressed as a problem for searching for a state of nodes minimizing the energy function of the interaction model, which is the ground state. An actual combinatorial optimization problem often involves a condition that a solution needs to satisfy, and such a condition is a constraint condition imposed between the nodes. Therefore, in order to solve a problem, it is important to efficiently obtain the state that minimizes the objective function while satisfying the constraint condition.

Among such constraint conditions, one of constraint conditions that frequently occurs in the actual combinatorial optimization problem is a k-hot constraint. The k-hot constraint is a constraint imposing that k binary variables (k is a positive integer and a binary variable has two states corresponding to on/off) in a set of binary variables are on. For example, as in a work shift scheduling problem or a vehicle routing problem, the k-hot constraint appears when allocating a specified number of things or matters, such as a work shift and a vehicle route, to a person in charge.

### SUMMARY OF THE INVENTION

The invention is made in view of the above background, and an object of the invention is to efficiently solve a quadratic programming problem having k-hot constraints (k is a positive integer) for binary variables.

A preferred aspect of the invention is an optimization method for, using an information processing apparatus, solving a quadratic programming problem in which one or more independent k-hot constraints (k is a positive integer) are imposed on binary variables, the information processing apparatus including a processor, a storage device, an input device, and an output device. The information processing apparatus relaxes the binary variables into continuous values by adding a correction value to nonlinear coefficients between the binary variables on which the k-hot constraints are imposed, and the information processing apparatus executes a solution search while satisfying the k-hot constraints by executing a state transition such that a sum of a set of continuous variables on which the k-hot constraint is imposed is constant.

Another preferred aspect of the invention is an information processing apparatus including a processor, a storage device, an input device, an output device, and an arithmetic device, and for solving a quadratic programming problem in which one or more independent k-hot constraints (k is a positive integer) are imposed on binary variables. The information processing apparatus includes: an energy arithmetic execution unit configured to relax, into continuous values, the binary variables on which the k-hot constraints are imposed; and a connection strength calculation unit configured to calculate a correction value to be added to nonlinear coefficients between the binary variables on which the k-hot constraints are imposed. Under control of the energy arithmetic execution unit, the arithmetic device executes a solution search while satisfying the k-hot constraint by executing a state transition such that a sum of a set of continuous variables on which the k-hot constraint is imposed is constant.

A problem and a method for solving the problem disclosed in the present application become apparent by the field of the description of the preferred embodiments and the drawings.

According to the invention, a quadratic programming problem having the k-hot constraint (k is a positive integer) for the binary variables can be efficiently solved. Other problems, configurations, and effects which are not described above become apparent by the description of the preferred embodiments.

### BRIEF DESCRIPTION OF THE DRAWINGS

FIG. 1 is a conceptual diagram of an energy landscape of an interaction model.

FIG. 2 is a conceptual diagram in which interaction relation between variables of the interaction model is represented as a complete graph and binary variables are relaxed into continuous values.

FIG. 3 is a conceptual diagram in which an adjacent matrix between nodes is converted into an alternative model having a complete bipartite graph structure in order to alternatively execute a ground state search for the interaction model expressed by the complete graph.

FIG. 4 is a diagram illustrating a method for updating the variables of an interaction model having the complete bipartite graph structure in FIG. 3.

FIG. 5A is a graph illustrating ranges of motion of xᵢ and xⱼ while keeping a sum of themconstant.

FIG. 5B is a graph illustrating a probability density function with which the variables comply within the ranges of motion in FIG. 5A.

FIG. 6 is a block diagram illustrating a schematic configuration of an information processing apparatus.

FIG. 7 is a block diagram of an arithmetic circuit.

FIG. 8 is a functional block diagram illustrating main functions of the information processing apparatus.

FIG. 9 is a flowchart illustrating ground state search processing.

FIG. 10 is a block diagram illustrating a detailed configuration example of an arithmetic device.

### DESCRIPTION OF EMBODIMENTS

Hereinafter, embodiments will be described in detail based on the drawings. In the following description, the same or similar configurations are denoted by common reference signs and the duplicated descriptions may be omitted. When there are a plurality of elements having the same or similar functions, the description may be made with the same reference signs having different subscripts. When it is not necessary to distinguish between a plurality of elements, the subscripts may be omitted for the description.

Notations such as “first”, “second”, and “third” in the present specification and the like are provided to identify components and do not necessarily limit the number, order, or contents thereof. In addition, numbers for identifying the components are used for each context, and numbers used in one context do not always illustrate the same configuration in other contexts. Further, it does not prevent the component identified by a certain number from having the function of the component identified by another number.

A position, size, shape, range, and the like of each configuration illustrated in the drawings and the like may not represent an actual position, size, shape, range, and the like in order to facilitate understanding of the invention. Therefore, the invention is not necessarily limited to the position, size, shape, range, and the like disclosed in the drawings and the like.

Publications, patents, and patent applications cited in the present specification constitute a part of the description of the present specification as the publications, patents, and patent applications are.

In the present specification, components represented in the singular are intended to include the plural unless the context clearly dictates otherwise.

The embodiment describes an optimization method for, using an information processing apparatus, solving a mixed binary quadratic programming (MBQP) problem having one or more independent k-hot constraints for binary variables. In this method, all binary variables are relaxed into continuous values after correcting nonlinear coefficients for the variables on which the k-hot constraints are imposed. A ground state search for an interaction model in which the binary variables are relaxed into the continuous values and the k-hot constraints are imposed is replaced with a ground state search for an interaction model in which an adjacent matrix is a bipartite graph structure and the k-hot constraints are imposed between the variables. The information processing apparatus includes an execution unit that searches for a ground state of the interaction model based on an energy function of the interaction model and information on the variables.

A problem and a method for solving the problem disclosed in the present application become apparent by the field of the description of the preferred embodiments and the drawings.

First, the interaction model will be described. The interaction model is defined by a plurality of nodes constituting a model, nonlinear coefficients acting between the nodes, and linear coefficients acting for each node. Here, it is assumed that a variable sᵢ corresponding to a node i (i=1 to N) is a continuous variable sᵢ∈[−1, 1] or a binary variable sᵢ∈{−1, 1}. An energy function H(s) (alternatively referred to as Hamiltonian) is defined based on the nonlinear coefficients and the linear coefficients of the interaction model. In particular, when interaction relations are defined for all node pairs, an energy function is the following quadratic expression.

$$H ( s ) := - \frac{1}{2} {s}^{⊤} Js - {h}^{⊤} s \qquad ( Expression 1 )$$

It can be considered that the energy function is expressed in which, in Expression 1, the first term is interaction between the nodes, and the second term is a bias for the node. Generally, the interaction model is expressed as an undirected graph, and a nonlinear term is specified by a set of variables included therein. Therefore, matrix J in Expression 1 is a real symmetric matrix.

The interaction model is a concept including the Ising model. When all variables are limited to the binary variable sᵢ∈{−1, 1} in the interaction model, the Ising model is obtained. The Ising model is used as, for example, a lattice model that describes a magnetic material in statistical mechanics, and +1/−1 corresponds to an up/down spin.

The ground state search for the interaction model is a combinatorial optimization problem for obtaining a variable array s that minimizes the energy function. In the present embodiment, the ground state search of the interaction model is executed by the Markov Chain Monte Carlo method (hereinafter, referred to as “MCMC”).

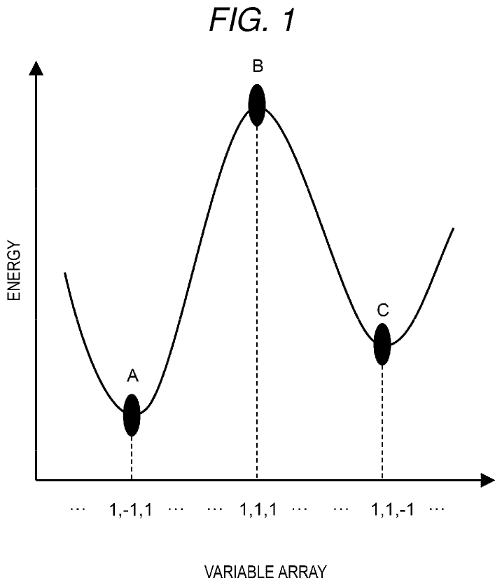

FIG. 1 is a conceptual diagram of an energy landscape of the interaction model. In the graph, a horizontal axis represents the variable array, and a vertical axis represents energy of a system. In a state transition according to the MCMC, a stochastic transition from a current state s to another state is repeated. Methods for sequentially executing a stochastic state transition include Gibbs sampling (or the heat bath method) and the Metropolis method. A probability distribution function with which the state s complies is set to p(s), and a state generated in the i-th step is set to s⁽ⁱ⁾={s₁⁽ⁱ⁾, . . . , s_{N}⁽ⁱ⁾}. In particular, in Gibbs sampling, the i+1-th state is generated sequentially according to a conditional probability in Expression 2 with n=1, . . . , N.

$${s}_{n}^{( i + 1 )} ∼ p ( {s}_{n} \vert {s}_{1}^{( i + 1 )} , … , {s}_{n - 1}^{( i + 1 )} , {s}_{n + 1}^{( i )} , … , {s}_{N}^{( i )} ) \qquad ( Expression 2 )$$

As such a sequential transition, for example, in the case of FIG. 1, −1 in a state A is inverted to 1 and the state A becomes a state B, and one 1 is updated to −1 and the state B becomes a state C.

When a parameter T for controlling the state transition is introduced and the MCMC is executed while gradually preventing the transition, the state asymptotically converges to a lowest energy state (ground state). A method for obtaining an optimal solution of a minimization problem based on the above approach is the simulated annealing (hereinafter, referred to as SA). Corresponding to real annealing, the parameter T is referred to as a temperature parameter.

When the MCMC or SA is applied to the interaction model, a variable value is stochastically updated based on Expression 2 and the like. Here, variables that do not have the nonlinear term and on which a constraint condition is not imposed are independent of each other in Expression 1 for the energy function and Expression 2 for a probability density function, and the state transitions based on Expression 2 can be simultaneously applied. Therefore, by updating the independent variables in parallel, it is possible to speed up processing executed by the MCMC or SA.

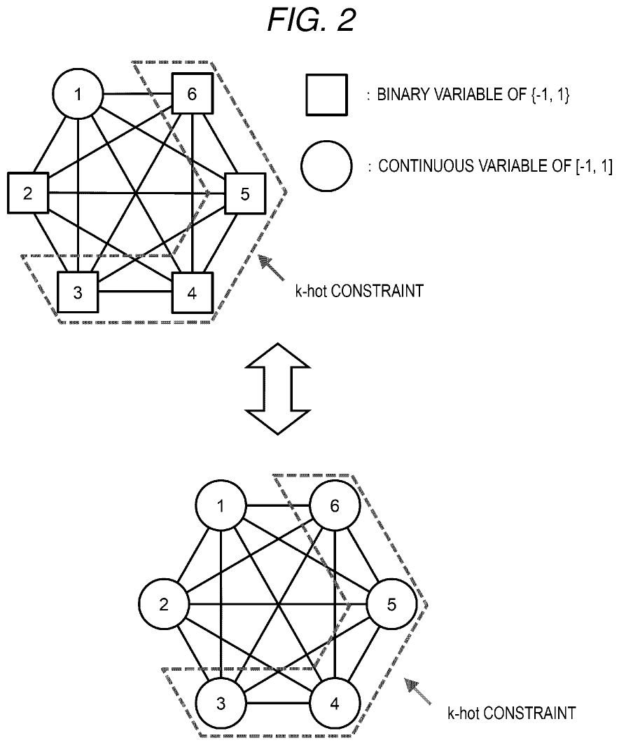

An upper part of FIG. 2 is a diagram in which interaction relation between the variables of the interaction model is represented as a complete graph. An enclosure defined by a dotted line illustrates a set of variables on which one k-hot constraint is imposed. Square nodes correspond to the binary variable of {−1, +1}, and a circle node corresponds to the continuous variable of [−1, +1]. A lower part is an interaction model in which the binary variables of the interaction model expressed in the upper part are relaxed into the continuous values to obtain real numbers.

In the upper part of FIG. 2, the number of the variables of the interaction model is N=6. Since there are interaction relations with non-zero nonlinear coefficients between all variables, the upper part of FIG. 2 is the complete graph (fully connected graph). When the combinatorial optimization problem is expressed as a ground state search problem of the interaction model, the interaction relation between the variables is often not independent of each other in the energy function as in the upper part of FIG. 2 because each variable is connected to many other variables.

Further, the constraint condition may be imposed on a possible state of the interaction model. A typical constraint condition is a k-hot constraint (k is an integer satisfying 0<k<n), which imposes k binary variables to be 1 for a set of n binary variables. Here, a case is considered in which there is no duplication in the variables between the k-hot constraints. For m=1, . . . , M kₘ-hot constraint (kₘ is an integer satisfying 0<kₘ<nₘ), the binary variable sᵢₘ∈{−1, 1} belonging to the constraint is limited as follows.

$${\sum }_{{i}_{m}} ( {s}_{{i}_{m}} + 1 ) / 2 = {k}_{m} \qquad ( Expression 3 )$$

The upper diagram of FIG. 2 illustrates a k-hot constraint when n=4. By imposing the k-hot constraint, possible states of a set of n binary variables are limited to ₙCₖ states, and therefore, it is no longer possible to independently update n variables to avoid the constraint violations. Therefore, for example, Patent Literature 1 proposes improving a processing speed by parallelizing calculation of energy functions of ₙCₖ possible feasible states.

As described above, stochastic update of the variable satisfying a theoretical background required by the MCMC cannot be executed simultaneously due to the fact that the variable is not independent in the energy function and the constraint condition, and therefore, it is difficult to speed up processing executed by the MCMC or SA. In particular, when k≥2 for the k-hot constraint, the number of candidates in a next state increases by _{L}Cₖ (L: dimension of a k-hot vector of interest), and therefore, it is difficult to efficiently update the state while changing as many variables as possible. Conversely, it is possible to speed up processing executed by the MCMC or SA if a plurality of spins can be updated simultaneously while satisfying the theoretical background by constructing a set of variables that are independent in the energy function and that can be moved simultaneously while satisfying the constraint condition.

Patent Literature 2 and Patent Literature 3 propose a method for, regarding a ground state search problem of a fully connected interaction model, efficiently obtaining a ground state by solving a ground state search problem of an alternative interaction model (hereinafter, referred to as an alternative model) having a complete bipartite graph structure when there is no constraint condition for variables.

In view of such a background, the present embodiment describes a method for solving a ground state search problem of an interaction model having a set of binary variables on which one or more independent k-hot constraints are imposed, through the ground state search problem of the alternative model in which the interaction relation has the complete bipartite graph structure.

First, attention is paid to the k-hot constraint imposed on the binary variable sᵢ∈{−1, 1} in the interaction model. A set of subscripts of variables on which the m-th k-hot constraint is imposed is set to Sₘ. A leading principal minor obtained by extracting a component in the i-th row and j-th column where i, j∈Sₘ from the matrix J in Expression 1 is set to Jₘ. At this time, a maximum eigenvalue of −Jₘ is represented by λₘ, and a constant dₘ=max {0, λₘ} is defined. At this time, a matrix obtained by adding dₘ to the i-th diagonal element of J (that is, Jᵢᵢ<-Jᵢᵢ+dₘ) is set to J′ if i∈Sₘ.

$${H}^{′} ( {s}^{′} ) := - \frac{1}{2} {s}^{′ ⊤} {J}^{′} {s}^{′} - {h}^{⊤} {s}^{′} \qquad ( Expression 4 )$$

At this time, it can be illustrated that a ground state of an interaction model represented by Expression 4 coincides with an optimal solution of an original mixed binary quadratic problem on which the k-hot constraints are imposed. Expression 4 satisfies Expression 3, and is obtained by relaxing all variables into continuous variables s′ᵢ ∈[−1, 1].

Generally, an optimization problem involving integer variables is referred to as an integer programming problem, and a case in which variables taking integer values and variables taking the real numbers are mixed is referred to as a mixed integer programming problem. A mixed integer programming problem in which an objective function is a quadratic function is referred to as a mixed integer quadratic programming problem, and in the present specification, in particular, a mixed integer quadratic programming problem in which variables taking binary values and variables taking the real numbers are mixed is referred to as a mixed binary quadratic programming problem.

Therefore, hereinafter, the matrix J′ is re-denoted as the matrix J, the energy function H′ is re-denoted as H, the binary variables are all relaxed into the continuous variables, and a domain of all variables is treated as sᵢ ∈[−1, 1]. In addition, the ground state of H(s) is set to s*.

The following model is considered in which a term including an auxiliary variable vector v∈R^{N} (where R is a set of real numbers) is added.

$$H ( s , v ) := H ( s ) + \frac{1}{2} {v}^{⊤} ( J + 2 wI ) v = - \frac{1}{2} {s}^{⊤} J s - {h}^{⊤} s + \frac{1}{2} {v}^{⊤} ( J + 2 wI ) v \qquad ( Expression 5 )$$

Here, I is an N-dimensional identity matrix. Here, if a magnitude of a connection w is larger than max {0, λ/2} with respect to a maximum eigenvalue À of an interaction matrix −J, J+2wI is a positive definite matrix, and therefore, v*=0 in a ground state of H(s, v). At this time, when a domain of s and v in Expression 5 is limited to Expression 6, the ground state of H(s, v) is also s*, v*=0.

$$\vert {s}_{i} \vert + \vert {v}_{i} \vert \leq 1 , ∀ i ∈ \{ 1 , … , N \} \qquad ( Expression 6 )$$

N-dimensional variable vectors x and y defined by s=(x+y)/2 and v=(x−y)/2 are introduced to s and v in Expression 6.

$$- 1 \leq {x}_{i} \leq 1 , - 1 \leq {y}_{i} \leq 1 , ∀ i ∈ \{ 1 , … , N \} \qquad ( Expression 7 )$$

At this time, Expression 7 is obtained. Further, when expression 5 is re-expressed by x and y, the following expression is obtained.

$$H ( x , y ) := 2 \{ H ( s ) + \frac{1}{2} {v}^{⊤} ( J + 2 wI ) v \} = - {x}^{⊤} J y - {h}^{⊤} ( x + y ) + \frac{w}{2} {‖ x - y ‖}^{2} \qquad ( Expression 8 )$$

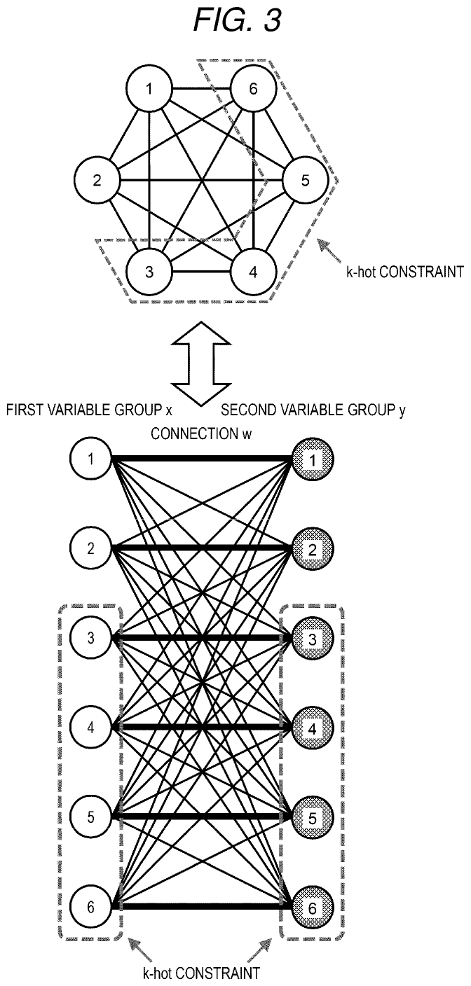

An upper diagram of FIG. 3 is the same as the interaction model in a lower diagram of FIG. 2. A lower diagram of FIG. 3 is an alternative model in which an adjacent matrix between nodes has a complete bipartite graph structure. The alternative model is used to alternatively execute the ground state search of the interaction model expressed in the upper diagram.

When interaction relation in Expression 8 is represented as the undirected graph, the lower diagram of FIG. 3 is obtained. In addition, as illustrated in the lower diagram of FIG. 3, by imposing the same k-hot constraint on x and y in Expression 8 as those imposed on s, s=(x+y)/2 also satisfies the k-hot constraint. Therefore, when the ground state of Expression 6 is set to x* and y* in a case in which the k-hot constraint is imposed on x and y, s*=x*=y* holds.

In an energy function expressed by Expression 8, xᵢ (yᵢ) of a variable group x (y) is independent of each other as illustrated in the lower part of FIG. 3.

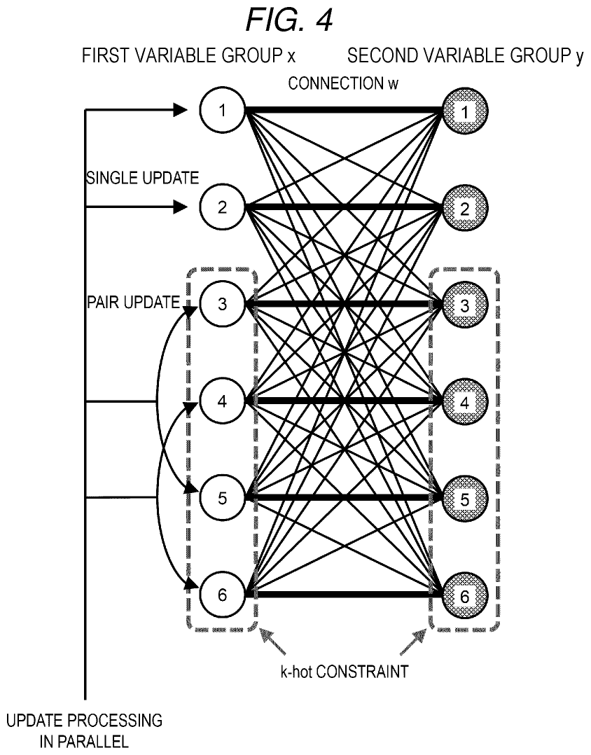

FIG. 4 illustrates a method for updating variables of the interaction model having the complete bipartite graph structure in FIG. 3. As illustrated in FIG. 4, each set of unconstrained variables or variables on which the independent k-hot constraint is imposed can be independently updated by the MCMC, and therefore, the processing executed by the MCMC or SA can be speeded up by parallel processing. Hereinafter, the parallel processing for this update will be described.

A state transitions according to Gibbs sampling for the energy function in Expression 8. As a temperature parameter T, it is assumed that a state {x, y} of the interaction model on a right side of Expression 8 appears in a probability density function p(x, y) based on a Boltzmann distribution.

$$p ( x , y ) = \frac{1}{Z} ex𝔭 ( - \frac{H ( x , y )}{T} ) \qquad ( Expression 9 )$$

Z is a normalization factor of the Boltzmann distribution referred to as a partition function. By applying Gibbs sampling to this Boltzmann distribution, it is possible to stochastically update x and y. As an example, a method for updating x based on given y is illustrated. When y is updated based on given x, an expression obtained by exchanging x and y may be applied. The following vector is defined.

$$g ( y ) := ( J + wI ) y + h \qquad ( Expression 10 )$$

First, a method for updating a variable xᵢ is illustrated on which the k-hot constraint is not imposed. The probability density functions with which xᵢ complies are Expressions 9 to 11.

$$p ( {x}_{i} \vert y ) ∝ exp ( - \frac{w}{2 T} {\{ {x}_{i} - ( {g}_{i} ( y ) / w ) \}}^{2} ) \qquad ( Expression 11 )$$

Here, a probability density function of a truncated normal distribution of a lower limit value l and an upper limit value u of a probability variable X is expressed by the following expression.

$$f ( X ; μ , σ , l , u ) : = ϕ ( \frac{X - μ}{σ} ) / \{ σ ( Φ ( \frac{u - μ}{σ} ) - Φ ( \frac{l - μ}{σ} ) ) \} \qquad ( Expression 12 )$$

Here, ϕ(⋅) is a probability density function of a standard normal distribution, and Φ(⋅) is a cumulative distribution function of the standard normal distribution. A method for randomly sampling a state following such a truncated normal distribution is described in Non-Patent Literature 1. Therefore, according to Expression 11, xᵢ may be randomly sampled from the truncated normal distribution of the following parameters.

$$l = - 1 , u = 1 , μ = {g}_{i} ( y ) / w , σ = T / w \qquad ( Expression 13 )$$

Next, a method for updating the variables on which the k-hot constraint are imposed is illustrated. As described above, the processing executed by the SA can be made more efficient by updating as many variables in parallel as possible. Therefore, here, a method is illustrated by which each pair of variables can be updated independently while satisfying the k-hot constraint by creating variable pairs in a set of variables on which the k-hot constraint is imposed as illustrated in FIG. 4.

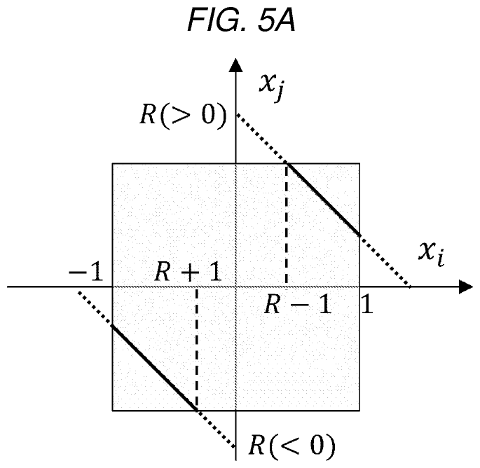

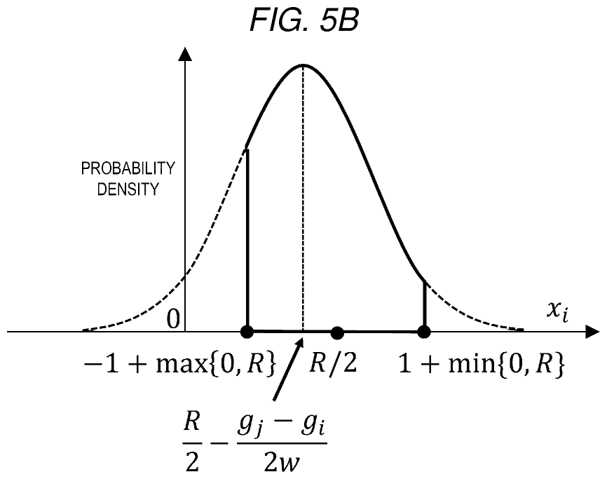

Solid lines in FIG. 5A are ranges of motion of xᵢ when a sum of the variable pair is constant.

FIG. 5B is a graph illustrating a probability density function with which the variables comply within the ranges of motion in FIG. 5A.

Two variables xᵢ and xⱼ are extracted from the variables on which the k-hot constraint is imposed. The k-hot constraint is always satisfied in a range in which these variables are moved with xᵢ+xⱼ=R constant. A range in which R is a constant value and xᵢ can be moved is as illustrated in FIG. 5A, and the probability density functions with which xᵢ complies are Expressions 8 to 14, that is, the truncated normal distribution as illustrated in FIG. 5B.

$$p ( {x}_{i} \vert {x}_{j} , y ) ∝ exp ( - \frac{w}{T} {\{ {x}_{i} - ( \frac{R}{2} - \frac{{g}_{j} ( y ) - {g}_{i} ( y )}{2 w} ) \}}^{2} ) \qquad ( Expression 14 )$$

Therefore, xᵢ may be randomly sampled from a truncated normal distribution of the following parameters.

$$l = - 1 + max \{ 0 , R \} , u = 1 + min \{ 0 , R \} , μ = \frac{R}{2} - \frac{{g}_{j} ( y ) - {g}_{i} ( y )}{2 w} , σ = \frac{T}{2 w} \qquad ( Expression 15 )$$

Further, xⱼ may be updated to xⱼ=R−xᵢ using xᵢ that is randomly sampled. The method for updating xᵢ and xⱼ in the pair illustrated here does not depend on other elements of x, and therefore, all variable pairs can be updated in parallel as illustrated in FIG. 4.

One method for creating the variable pairs is to randomly create floor (n/2) (a floor function floor (⋅) means a largest integer less than or equal to ⋅) variable pairs from n variables on which the k-hot constraint is imposed. As another method, it is also conceivable to create the variable pairs such that the variable value changes as much as possible by update based on Expression 14. As illustrated in a lower part of FIG. 5, in order to avoid localization of distribution of xᵢ, gᵢ and gⱼ are desirably close to 0, and therefore, it is conceivable to create the variable pairs to implement this desirable matter. Furthermore, as another method based on the same idea, it is conceivable to define the variable pairs such that a value of variance of the distribution in Expression 14 becomes large.

In order to implement these methods, it is conceivable that an energy arithmetic execution unit 815 defines the variable pairs based on a rule in which a change in the variable obtained by the update is equal to or greater than a predetermined threshold. Alternatively, it is conceivable to define the variable pairs based on a rule in which absolute values of gᵢ and gⱼ are equal to or less than the predetermined threshold. Alternatively, it is conceivable to define the variable pairs based on a rule in which the value of variance of the truncated normal distribution for sampling the variable is equal to or greater than the predetermined threshold.

Next, an embodiment of the information processing apparatus that executes the ground state search is illustrated.

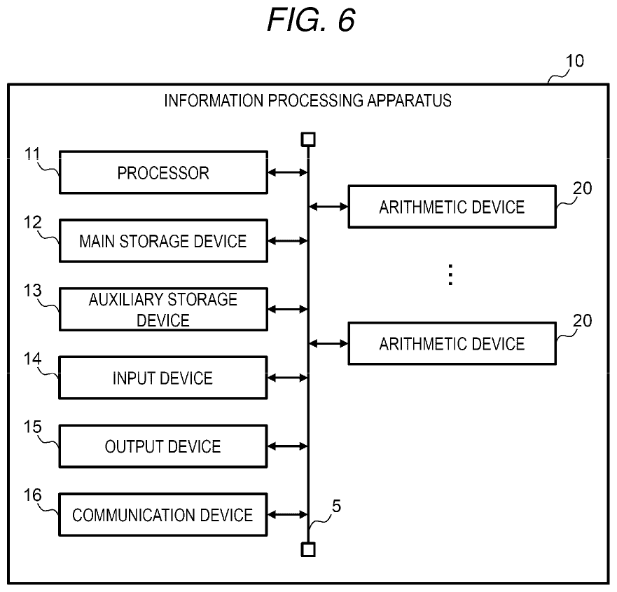

An information processing apparatus 10 illustrated in FIG. 6 includes a processor 11, a main storage device 12, an auxiliary storage device 13, an input device 14, an output device 15, a communication device 16, one or more arithmetic devices 20, and a system bus 5 that communicably connects these devices. For example, the information processing apparatus 10 may be implemented using a virtual information processing resource such as a cloud server of which a part or all is provided by a cloud system. Further, for example, the information processing apparatus 10 may be implemented by a plurality of information processing apparatuses that operate in cooperation with each other and that are communicably connected to each other.

The processor 11 includes, for example, a central processing unit (CPU) or a micro processing unit (MPU). The main storage device 12 is a device that stores a program or data, and is, for example, a read only memory (ROM) (a static random access memory (SRAM), a non volatile RAM (NVRAM), a mask read only memory (mask ROM), a programmable ROM (PROM), and the like), and a random access memory (RAM) (a dynamic random access memory (DRAM), and the like). The auxiliary storage device 13 is a hard disk drive, a flash memory, a solid state drive (SSD), an optical storage device (a compact disc (CD), a digital versatile disc (DVD), and the like), and the like. A program or data stored in the auxiliary storage device 13 is read into the main storage device 12 at any time.

The input device 14 is a user interface that receives information from a user, and is, for example, a keyboard, a mouse, a card reader, and a touch panel. The output device 15 is a user interface that provides information to the user, and is, for example, a display device (a liquid crystal display (LCD), a graphic card, and the like) that visualizes various kinds of information, an audio output device (speaker), and a printing device. The communication device 16 is a communication interface that communicates with other devices, and is, for example, a network interface card (NIC), a wireless communication module, a universal serial interface (USB) module, and a serial communication module.

The arithmetic device 20 is a device that executes the ground state search. The arithmetic device 20 may take a form of an expansion card to be mounted on the information processing apparatus 10, such as a graphics processing unit (GPU). The arithmetic device 20 is implemented by, for example, hardware such as a complementary metal oxide semiconductor (CMOS) circuit, a field programmable gate array (FPGA), and an application specific integrated circuit (ASIC). The arithmetic device 20 includes a control device, a storage device, an interface for connection to the system bus 5, and the like, and transmits and receives a command and information to and from the processor 11 via the system bus 5. For example, the arithmetic device 20 may be one that is communicably connected to another arithmetic device 20 via a communication line and that operates in cooperation with the other arithmetic device 20. A function implemented by the arithmetic device 20 may be implemented by, for example, causing a processor (CPU, GPU, and the like) to execute the program.

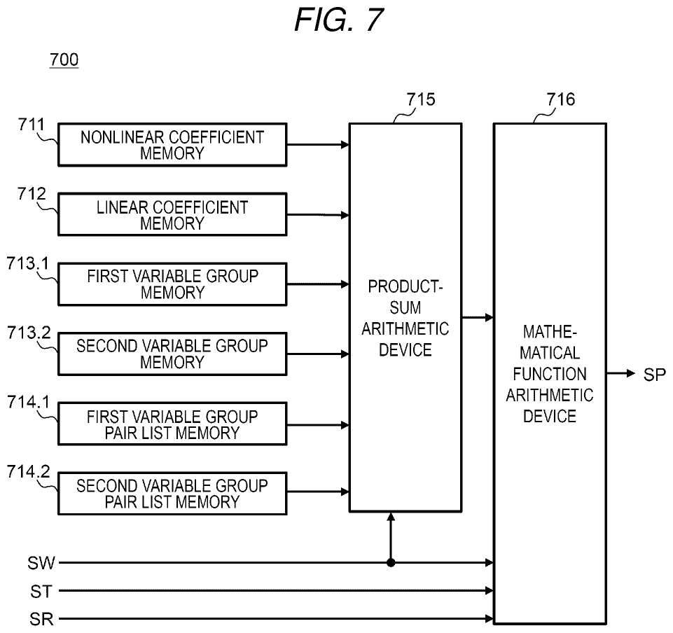

FIG. 7 is a diagram illustrating an operation principle of the arithmetic device 20, and is a block diagram of a circuit (hereinafter, referred to as an arithmetic circuit 700) that constitutes the arithmetic device 20. The arithmetic circuit 700 implements a function corresponding to an update expression. Hereinafter, the operation principle of the arithmetic device 20 is described with reference to FIG. 7.

As illustrated in FIG. 7, the arithmetic circuit 700 includes a nonlinear coefficient memory 711, a linear coefficient memory 712, a D-th variable group memory 713.D (D=1, 2), a D-th variable group pair list memory 714.D (D=1, 2), a product-sum arithmetic device 715, and a mathematical function arithmetic device 716.

The nonlinear coefficient memory 711 stores information representing a real symmetric matrix J including the nonlinear coefficient representing the interaction between the nodes and connection w (see Expression 5). As described above, an interaction matrix is the real symmetric matrix, and therefore, the use amount of the nonlinear coefficient memory 711 can be reduced using this symmetry.

The linear coefficient memory 712 stores information representing a linear coefficient vector h (see Expression 5).

The D-th variable group memory 713.D (D=1, 2) stores information on an N-dimensional vector illustrating a state of a D-th variable group of the above alternative model (see Expression 5). The D-th variable group memory 713.D can store the real number (continuous value).

Signals SW, SR, and ST are input into the arithmetic circuit 700. The mathematical function arithmetic device 716 outputs a signal SP.

The signal SW is a signal that periodically repeats integers 1 and 2, and designates the first variable group memory and the second variable group memory.

The signal SR is a signal representing a vector in which elements are random numbers that are independent of each other. A random number used in stochastic update described in Non-Patent Literature 1 is input.

The signal ST inputs the temperature parameter T in the SA.

As described above in the description regarding Expression 5, the connection w is set based on eigenvalue information of the matrix J. Numerical evaluation may be executed outside the arithmetic device 20 by, for example, the processor 11. Calculation is also possible within the arithmetic device 20. For example, when the maximum eigenvalue is calculated by a power method or the like, the matrix and vector product is repeatedly executed, and the product-sum arithmetic device 715 can be utilized.

Contents of the nonlinear coefficient memory 711, the linear coefficient memory 712, the D-th variable group memory 713.D, and the signal SW are input into the product-sum arithmetic device 715. Expression 10 includes product-sum arithmetic of the matrix and the vector, and the arithmetic is executed under a correspondence relation of variables specified by the signal SW, and a result is output.

The random sampling of the truncated normal distribution in Non-Patent Literature 1 includes arithmetic of a mathematical function such as an error function for an output of the product-sum arithmetic and a uniform random number r, which is executed by the mathematical function arithmetic device 716. The signal SW specifies an expression to which the arithmetic to be executed corresponds. Further, the uniform random number r and the temperature parameter T are received from the signal SR and the signal ST, respectively. A variable value updated according to the MCMC, which is an output value, is output to the signal SP.

The description of the ranges disclosed in Patent Literature 2 and Patent Literature 3 is omitted in the present specification, and the state transition of the variable is sequentially executed by the stochastic state transition according to an algorithm of the simulated annealing. Here, the arithmetic for the update expression can be independently executed for the independent variables and the variable pairs of each variable group. That is, a next state is stochastically determined by the MCMC such that variables on which the k-hot constraint is not imposed are independent and a sum of the variables on which the k-hot constraint is imposed is constant for the set of variables. Accordingly, the variable can be updated in parallel by a plurality of arithmetic circuits 700, and the MCMC can be speeded up. A degree of freedom in updating the variable is also large even when the k-hot constraint is imposed.

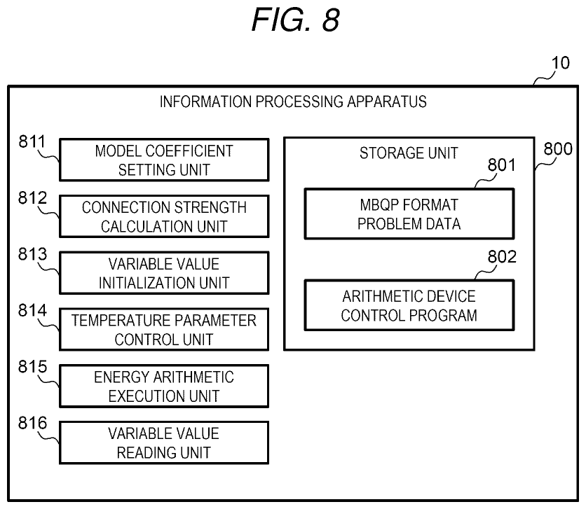

FIG. 8 illustrates main functions (software configurations) of the information processing apparatus 10. As illustrated in FIG. 8, the information processing apparatus 10 includes a storage unit 800, a model coefficient setting unit 811, a connection strength calculation unit 812, a variable value initialization unit 813, a temperature parameter control unit 814, the energy arithmetic execution unit 815, and a variable value reading unit 816. These functions are implemented by the processor 11 reading and executing the program stored in the main storage device 12 or by hardware provided in the arithmetic device 20. The information processing apparatus 10 may have other functions such as an operating system, a file system, a device driver, and a database management system (DBMS), in addition to the above functions.

Among the above functions, the storage unit 800 stores MBQP format problem data 801 and an arithmetic device control program 802 in the main storage device 12 or the auxiliary storage device 13. The MBQP format problem data 801 is data in which the combinatorial optimization problem is input in a predetermined description format, and holds the constraint condition such as the nonlinear coefficient, the linear coefficient, and the k-hot constraint. The user sets the MBQP format problem data 801 via the user interface (input device, output device, communication device, or the like), for example.

The arithmetic device control program 802 is a program that is executed when the energy arithmetic execution unit 815 controls the arithmetic device 20, or is loaded by the energy arithmetic execution unit 815 into each of the arithmetic devices 20 and executed by the arithmetic device 20.

When the MBQP format problem data 801 is the mixed binary quadratic problem, based on the arithmetic device control program 802, the energy arithmetic execution unit 815 relaxes into the continuous value binary variable of the MBQP format problem data 801 on which the k-hot constraint is imposed. That is, the variable can take the real number. Variable pairs are created in a k-hot vector, and control is executed such that the state is updated while keeping the sum of the variable pairs constant. The storage unit 800 may store in advance the MBQP format problem data 801 that is relaxed into the continuous values.

After the optimum solution is obtained, the energy arithmetic execution unit 815 executes control to restore the continuous variable to the binary variable. Conversion of the binary variable and the continuous variable can be executed based on the disclosure of Patent Literature 3.

The model coefficient setting unit 811 sets the nonlinear coefficient memory 711 and the linear coefficient memory 712 based on the MBQP format problem data 801.

Based on information on the nonlinear coefficient memory 711, the connection strength calculation unit 812 sets a value of the connection w based on an eigenvalue of the interaction matrix.

The variable value initialization unit 813 initializes a value stored in a variable memory of the arithmetic device 20. For example, setting is executed based on a uniform random number from −1 to +1 while satisfying each k-hot constraint.

The temperature parameter control unit 814 controls the temperature parameter T in the SA.

The energy arithmetic execution unit 815 executes a ground state search (hereinafter, referred to as energy arithmetic) according to the SA for the interaction model. Therefore, the energy arithmetic execution unit 815 also executes overall control to cause other parts such as the model coefficient setting unit 811, the connection strength calculation unit 812, the variable value initialization unit 813, the temperature parameter control unit 814, and the variable value reading unit 816 to execute necessary processing.

When the SA is executed by the energy arithmetic execution unit 815, the variable value reading unit 816 reads the value stored in the variable memory and outputs the read value to the output device 15 or the communication device 16, thereby ending the ground state search.

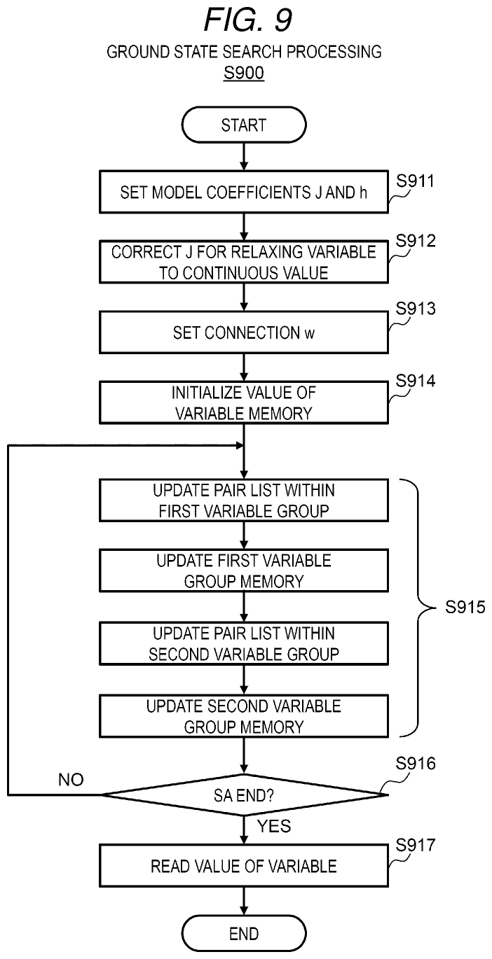

FIG. 9 is a flowchart illustrating processing (hereinafter, referred to as ground state search processing S900) executed by the information processing apparatus 10 during the ground state search of the interaction model. Hereinafter, the ground state search processing S900 is described with reference to FIG. 9. In the following, the letter “S” attached in front of reference signs means a processing step. The ground state search processing S900 is started by receiving an instruction or the like from the user via the input device 14, for example.

First, the model coefficient setting unit 811 sets values in the nonlinear coefficient memory 711 and the linear coefficient memory 712 of the arithmetic device 20 (arithmetic circuit 700) based on the MBQP format problem data 801 (S911). The values of the memory can also be set or edited by the user via the user interface (which includes, for example, the input device 14, the output device 15, and the communication device 16).

Subsequently, the connection strength calculation unit 812 sets a correction value d based on the k-hot constraint and the matrix J that are stored in the nonlinear coefficient memory 711 and stores the correction value d in the nonlinear coefficient memory 711 again. As described above, this calculation may be executed in the arithmetic device 20 or by the processor 11 (S912). The connection strength calculation unit 812 calculates the constant dₘ=max {0, λₘ} as the correction value d as described above.

Subsequently, the connection strength calculation unit 812 sets the connection w based on the matrix J′ (the matrix J′ obtained by Jᵢᵢ<-Jᵢᵢ+dₘ) that incorporates the correction value d stored in the nonlinear coefficient memory 711 and stores the connection w in the nonlinear coefficient memory 711 again. As described above, this calculation may be executed in the arithmetic device 20 or by the processor 11 (S913).

Subsequently, the variable value initialization unit 813 initializes the value stored in the variable memory (S914). The energy arithmetic execution unit 815 redefines the binary variable defined in the MBQP format problem data 801 as the continuous variable, and therefore, the variable value is the continuous value.

Subsequently, the energy arithmetic execution unit 815 updates a pair list, which is a list of variables updated in pairs based on information of a random or probability density function, and stores the pair list in the D-th variable group pair list memory 714. The arithmetic circuit 700 updates a value of the D-th variable group memory 713 based on a result of the energy arithmetic execution unit 815. This operation is alternately applied to a first variable group and a second variable group (S915).

A method in which the arithmetic device 20 (arithmetic circuit 700) updates the state (updates the variable) and transitions the state to the ground state may follow, for example, the methods in Patent Literature 2 and Patent Literature 3. However, in the present embodiment, after the variable is relaxed into the continuous value, based on a content of the D-th variable group pair list memory 714, control is executed to keep a sum of values of predetermined variable pairs constant. Since the variable pairs can be updated independently without affecting other variables, all variable pairs can be updated in parallel.

Subsequently, the energy arithmetic execution unit 815 determines whether an SA end condition is satisfied (for example, whether the state is updated while changing the temperature parameter T a predetermined number of times) (S916). When the energy arithmetic execution unit 815 determines that the SA end condition is satisfied (S916: YES), the processing proceeds to S917. On the other hand, when the energy arithmetic execution unit 815 determines that a stop condition is not satisfied (S916: NO), the processing returns to S915.

Subsequently, the variable value reading unit 917 reads the value stored in the variable memory and stores the value as a result of the ground state search (S917), and the ground state search processing S900 ends.

The energy arithmetic execution unit 815 executes processing of returning the continuous variable of the solution to the binary variable based on the result of the ground state search. For example, a binary variable of −1 or +1 may be obtained based on a reference sign of the continuous variable.

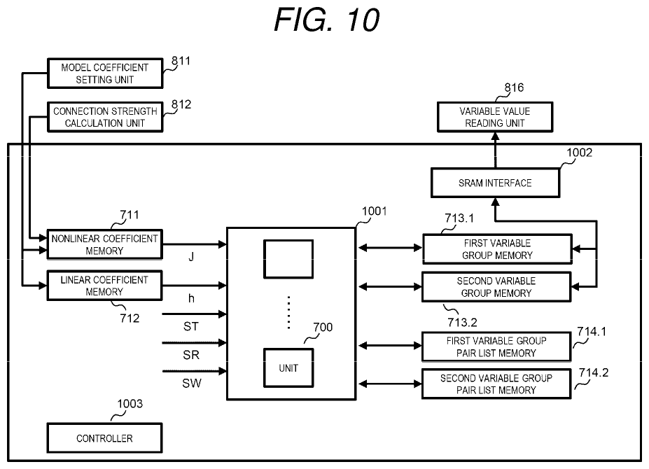

FIG. 10 is a block diagram illustrating a detailed configuration example of the arithmetic device 20, and is a block diagram illustrating a circuit configuration example in a case in which an SRAM technology is applied to the present embodiment to obtain a semiconductor integrated circuit. Units that execute an operation of the arithmetic circuit 700 constitute an array unit 1001. Such a configuration can be manufactured by applying a semiconductor manufacturing technology.

The configuration example in FIG. 10 will be described. Data stored in the nonlinear coefficient memory 711 and the linear coefficient memory 712 is set by the model coefficient setting unit 811. The matrix J is stored in the nonlinear coefficient memory 711, and the linear coefficient vector h is stored in the linear coefficient memory 712. The matrix J and the linear coefficient vector h are commonly used in all units in order to reduce a circuit scale. Signal lines therefor are omitted in FIG. 10. In principle, each unit may have these memories individually.

An SRAM interface 1002 executes write and read to and from a variable group memory. A variable value read after the processing in the arithmetic circuit 700 ends is sent to the variable value reading unit 816. The variable value reading unit 816 outputs the result of the ground state search by appropriately storing and outputting the read value.

A controller 1003 executes initialization in each memory and an end report of arithmetic processing of the units according to an instruction from the energy arithmetic execution unit 815.

Although one embodiment is described in detail as above, the invention is not limited to the above embodiment, and, of course, can be modified in various ways within a scope not departing from a gist thereof. For example, the above embodiment is described in detail in order to describe the invention in an easily understandable manner, and is not necessarily limited to one including all the configurations described above. Further, another configuration can be added, deleted, replaced with respect to a part of the configuration of the above embodiment.

Each of the above configurations, functional units, processing units, processing methods, and the like may be implemented by hardware by designing a part or all of the above configurations, functional units, processing units, processing methods, and the like by, for example, an integrated circuit. Further, each of the above configurations, functions, and the like may be implemented by software by the processor interpreting and executing a program for implementing each function. Information such as the program, a table, and a file for implementing each function can be stored in a recording device such as a memory, a hard disk, and a solid state drive (SSD), or a recording medium such as an IC card, an SD card, and a DVD.

In the above drawings, control lines and information lines considered to be necessary for the description are illustrated, and not all the control lines and information lines required for implementation are necessarily illustrated. For example, in practice, it may be considered that almost all configurations are connected to each other.

An arrangement form of various functional units, various processing units, and various databases of the information processing apparatus 10 described above are merely examples. The arrangement form of the various functional units, the various processing units, and the various databases can be changed to an optimal arrangement form from the viewpoint of performance, processing efficiency, communication efficiency, or the like of hardware and software that are provided in the information processing apparatus 10.

A configuration (schema or the like) of the database that stores various types of data described above can be flexibly changed from the viewpoint of efficient use of resources, improvement in processing efficiency, improvement in access efficiency, improvement in search efficiency, or the like.

As described above, the information processing apparatus changes the mixed binary quadratic optimization problem having the k-hot constraint for the binary variable to the quadratic programming problem having the k-hot constraint by adding the correction value to the nonlinear coefficients based on information on the k-hot constraint and the nonlinear coefficients. An optimal solution search for this quadratic programming problem is executed by the ground state search for the interaction model having the complete bipartite graph structure when the nonlinear coefficients are expressed as the adjacent matrix. This ground state search is executed by updating the variable according to the simulated annealing based on information on the energy function and the variable of the interaction model. By such a method, the mixed binary quadratic optimization problem having the k-hot constraints for the binary variables is solved by relaxing the binary variables into the continuous value, thereby improving the processing speed.

As described above, it is possible to provide a method for efficiently executing an optimal solution search for the mixed binary quadratic optimization problem based on relaxation of the binary variable into the continuous value and the parallel processing using the relaxation. The mixed binary quadratic optimization problem has one or more independent k-hot constraints for the binary variable.

What is claimed is:

1. An optimization method for, using an information processing apparatus, solving a quadratic programming problem in which one or more independent k-hot constraints (k is a positive integer) are imposed on binary variables, the information processing apparatus including a processor, a storage device, an input device, and an output device, wherein
the information processing apparatus relaxes the binary variables into continuous values by adding a correction values to nonlinear coefficients of the binary variables on which the k-hot constraints are imposed, and
the information processing apparatus executes a solution search while satisfying the k-hot constraints by executing state transitions such that a sum of a set of continuous variables on which the k-hot constraint is imposed is constant.

2. The optimization method according to claim 1, wherein
the correction value of the nonlinear coefficient of the binary variables on which the k-hot constraint is imposed is determined based on an eigenvalue of a principal submatrix obtained by the information processing apparatus extracting the nonlinear coefficients between the binary variables on which the k-hot constraint is imposed.

3. The optimization method according to claim 1, wherein
the information processing apparatus stores two variable groups x and y each having N variables, stores an N-dimensional real symmetric matrix J defined by the nonlinear coefficients and a vector h defined by a linear coefficient between the variables of the quadratic programming problem, and calculates a connection strength w, which is determined based on information on an eigenvalue of the N-dimensional real symmetric matrix J, between an i-th variable pair xᵢ, yᵢ of the two variable groups.

4. The optimization method according to claim 3, wherein
the solution search is executed by executing a ground state search for an interaction model in which, between the two variable groups x and y, the N-dimensional real symmetric matrix J acts as an adjacent matrix, the vector h acts as a bias coefficient for x and y, and an undirected graph with x and y expressed as nodes is a complete bipartite graph structure.

5. The optimization method according to claim 4, wherein
the ground state search is executed by sequentially executing a state transition of the variables by a stochastic state transition according to an algorithm of simulated annealing.

6. The optimization method according to claim 5, wherein
the state transition is executed simultaneously for a plurality of variables belonging to the variable group x or Y,
a next state is stochastically determined by markov chain monte carlo methods such that variables on which the k-hot constraint is not imposed are independent and a sum of the variables on which the k-hot constraint is imposed is constant for a set of variables.

7. The optimization method according to claim 1, wherein
the quadratic programming problem is a mixed binary quadratic programming problem.

8. The optimization method according to claim 1, wherein
the information processing apparatus randomly determines the set of continuous value variables.

9. The optimization method according to claim 1, wherein
the information processing apparatus determines the set of continuous value variables such that changes in the variables in the state transition are equal to or greater than a predetermined threshold.

10. An information processing apparatus including a processor, a storage device, an input device, an output device, and an arithmetic device, and for solving a quadratic programming problem in which one or more independent k-hot constraints (k is a positive integer) are imposed on binary variables, the information processing apparatus comprising:
an energy arithmetic execution unit configured to relax, into continuous values, the binary variables on which the k-hot constraints are imposed; and
a connection strength calculation unit configured to calculate a correction value to be added to a nonlinear coefficient of the binary variables on which the k-hot constraint is imposed, wherein
under control of the energy arithmetic execution unit, the arithmetic device executes a solution search while satisfying the k-hot constraint by executing a state transitions such that a sum of a set of continuous variables on which the k-hot constraint is imposed is constant.

11. The information processing apparatus according to claim 10, wherein
the connection strength calculation unit calculates the correction value of the nonlinear coefficient of the binary variables on which the k-hot constraint is imposed, based on an eigenvalue of a principal submatrix obtained by extracting the nonlinear coefficient between the binary variables on which the k-hot constraint is imposed.

12. The information processing apparatus according to claim 11, wherein
the arithmetic device is implemented by a semiconductor integrated circuit, and includes a variable memory configured to store two variable groups x and y each having N variables, and a nonlinear coefficient memory configured to store an N-dimensional real symmetric matrix J defined by the nonlinear coefficient between the variables of the quadratic programming problem, and
the connection strength calculation unit calculates, based on information on the nonlinear coefficient memory, a connection strength w, which is determined based on information on an eigenvalue of the N-dimensional real symmetric matrix J, between an i-th variable pair xᵢ, yᵢ of the two variable groups.

13. The information processing apparatus according to claim 12, wherein
the arithmetic device includes a linear coefficient memory configured to store a vector h that is a bias coefficient for x and y, and
the arithmetic device executes a ground state search for an interaction model in which, between the two variable groups x and y, the N-dimensional real symmetric matrix J acts as an adjacent matrix, the vector h acts on x and y, and an undirected graph with x and y expressed as nodes is a complete bipartite graph structure.

14. The information processing apparatus according to claim 13, wherein
the arithmetic device executes the ground state search by sequentially executing a state transition of the variables by a stochastic state transition according to an algorithm of simulated annealing.

15. The information processing apparatus according to claim 14, wherein
the state transition is executed simultaneously for a plurality of variables belonging to the variable group x or y,
a next state is stochastically determined by markov chain monte carlo methods such that variables on which the k-hot constraint is not imposed are independent and a sum of the variables on which the k-hot constraint is imposed is constant for a set of variables.
